(19) United States
(12) Patent Application Publication
(10) Pub. No.: US 2025/0336960 A1
(43) Pub. Date: Oct. 30, 2025

(54) SILICON ANODE FOR SOLID-STATE BATTERY AND SOLID-STATE BATTERY COMPRISING THE SAME

(71) Applicant: SEOUL NATIONAL UNIVERSITY R&DB FOUNDATION, Seoul (KR)

(72) Inventors: Jongwoo LIM, Seoul (KR); Ikcheon NA, Seoul (KR)

(21) Appl. No.: 18/289,422

(22) PCT Filed: Sep. 20, 2023
(86) PCT No.: PCT/KR2023/014308

§ 371 Date: Jan. 3, 2025

(30) Foreign Application Priority Data
Dec. 6, 2022 (KR) 10-2022-0168751
Aug. 30, 2023 (KR) 10-2023-0114610

(51) Int. Cl. H01M 4/38; H01M 4/02; H01M 4/04; H01M 4/134

(52) U.S. Cl. CPC H01M 4/386; H01M 4/043; H01M 4/134; H01M 2004/021; H01M 2004/027; H01M 2300/0068

(57) ABSTRACT

The present invention relates to a silicon anode for a solid-state battery including Si atoms of 99 wt % or more and composed of crystalline Si.

### CROSS-REFERENCE TO RELATED APPLICATION

The present application claims priority to and the benefit of Korean Patent Applications No. 10-2022-0168751 filed in the Korean Intellectual Property Office on Dec. 6, 2022, and Korean Patent Applications No. 10-2023-0114610 filed in the Korean Intellectual Property Office on Aug. 30, 2023, and all of the disclosures in those Korean patent applications are hereby incorporated by reference as part of this specification.

### TECHNICAL FIELD

The present invention relates to a silicon anode for a solid-state battery and a solid-state battery including the same.

### BACKGROUND ART

As an energy supply source that converts chemical energy into electric energy, a lithium-ion battery is receiving attention for the contribution to minimizing greenhouse gas and harmful gas emissions. The lithium-ion battery is gaining attention not only as an IT device in mobile phones, laptops, and wearable devices, but also as an energy source for medium and large-scale batteries such as electric vehicles and power storage devices. However, since a liquid electrolyte used in the current Li-ion battery has a relatively limited charge and discharge voltage range, the battery has low energy density to be used in electric vehicles and power storage devices, and is vulnerable to external shocks, resulting in stability problems such as battery explosion and leakage. Therefore, a number of researches have been conducted on a solid electrolyte that has high energy density, is safe from external shocks, and can be processed into various shapes.

Meanwhile, researches are focusing on developing high-capacity, high-voltage anode materials to increase energy density. For example, graphite, one of the commercially available anode materials, has a theoretical maximum capacity of 372 mAh/g, but when silicon is used as an anode material, the theoretical maximum capacity is 3570 mAh/g, which is approximately 9 times higher. However, the silicon as an anode material, or a silicon anode, expands and contracts as lithium is repeatedly inserted and removed, and the maximum volume expansion reaches approximately 280%, putting high stress on silicon particles. In addition, in the battery including the silicon anode and liquid electrolyte, the silicon anode expands and contracts, causing the silicon particles to crack and fall apart over a long period of charge and discharge. When the particles fall apart, electrons can no longer be transferred, resulting in an unusable portion, so post-processing such as particle coating is essential to extend the lifespan. However, the post-processing process causes the weight or volume of the silicon particles to increase, and the energy capacity and density to decrease. In addition, the maximum capacity of the silicon solid-state battery reported to date is approximately 4 mAh/cm² at room temperature, but research is needed to achieve the theoretical maximum capacity of the silicon anode.

### DISCLOSURE

### Technical Problem

The present invention is invented to overcome the above disadvantages, and is directed to providing a silicon anode for a solid-state battery including Si atoms of 99 wt % or more and composed of crystalline Si, and a solid-state battery including the same.

### Technical Solution

The present invention is directed to providing a silicon anode for a solid-state battery including Si atoms of 99 wt % or more and composed of crystalline Si.

### Advantageous Effects

When the silicon anode for a solid-state battery according to the present invention is used, the battery may have a capacity of 10 mAh/cm² or more. In addition, silicon has abundant reserves compared to lithium metal, making it more economical and has less dendritic growth, which can cause battery malfunctions.

In addition, unlike an existing silicon electrode, the silicon anode according to the present invention does not include a conductor and a binder, which enables the energy density to increase to an extreme level. Further, in the present invention, a silicon wafer is used as a silicon anode, and the density of the silicon anode is very high, resulting in a high energy density compared to a conventional silicon anode.

### DESCRIPTION OF DRAWINGS

FIG. 1 is a result of a charge and discharge test of a half cell including a silicon wafer of Example 1 as an anode, fixed at 0.5 mA/cm² at room temperature.

FIG. 2 is a result of a charge and discharge test of half cells including silicon wafers of Examples 1 to 3 as an anode and liquid electrolyte of Comparative Example 2, fixed at 0.5 mA/cm² at room temperature.

FIG. 3 is a result of a charge and discharge test of half cells containing silicon wafers of Examples 1 and 4 and silicon particles of Comparative Example 1 as an anode, fixed at 0.5 mA/cm² at room temperature.

### BEST MODES OF THE INVENTION

The present invention provides a silicon anode for a solid-state battery.

In an embodiment of the present invention, the silicon anode of the present invention may be a silicon anode including Si atoms of 98 wt %, 99 wt %, 99.9 wt %, or 99.99 wt % or more. As the content of Si atoms in the silicon anode satisfies the range described above, the energy density of the silicon anode may increase.

In an embodiment of the present invention, the silicon anode may have an average long axis length (L) of 1 to 500 mm, 1 to 250 mm, or 1 to 100 mm. As the average long axis length of the silicon anode of the present invention satisfies the range described above, the anode may serve as a single crystal and single particle, exhibiting suitable mechanical and electrochemical characteristics even without the inclusion of a binder.

In an embodiment of the present invention, the silicon anode may have a plate-like shape. Since the shape of the silicon anode is plate-like, the insertion and removal of lithium ions may proceed in only one crystalline direction, which can efficiently increase the capacity of the battery and has excellent mechanical properties.

In an embodiment of the present invention, a ratio (L/d) of the average long axis length (L) to an average thickness (d) of the silicon anode may be 5 to 100, 10 to 90, or 20 to 80. As the ratio (L/d) of the average long axis length (L) to the average thickness (d) of the silicon anode satisfies the range described above, the silicon anode is mechanically stable without problems such as bending, and the insertion and removal of lithium ions may proceed efficiently, resulting in excellent electrochemical properties.

In an embodiment of the present invention, the silicon anode may be in the form of a wafer. The silicon wafer may be manufactured through several processes such as single crystal growing, then slicing into silicon wafers with a wire saw, etc. and lapping, etching, polishing, and cleaning. Since the silicon anode is in the form of a wafer, it is possible to use the silicon wafer process facilities of the semiconductor factory already established and reduce production costs by using the existing lines without the need to build additional lines.

In an embodiment of the present invention, the silicon anode may be crystalline or amorphous Si, and the silicon anode may be polycrystalline or monocrystalline Si.

In an embodiment of the present invention, the silicon anode may be in the form of a wafer including unevenness on a surface thereof. By forming unevenness on the surface of the silicon anode, the surface area increases, allowing the silicon anode to be in closer contact with the solid electrolyte, which enables efficient and uniform distribution of lithiation current across the entire surface of the silicon anode.

An arithmetic average roughness (Ra) value of the silicon anode surface may be 1 to 10 μm, preferably, the arithmetic average roughness (Ra) value may be 2 to 10 μm, and even more preferably, the arithmetic average roughness (Ra) value may be 2 to 5 μm. By forming unevenness on the surface of the silicon anode within the range described above, uniform contact with the solid electrolyte may be achieved. However, when the range is exceeded, uneven contact with the solid electrolyte may result in delamination, and battery life may be impaired.

In an embodiment of the invention, when the silicon anode is composed of a crystalline material, the crystal orientation of the silicon anode may include at least one selected from the group consisting of (100) plane, (110) plane, and (111) plane as a Miller index. The crystal orientation of the anode may be selected and used depending on the purpose of use, taking into account electrochemical and mechanical characteristics.

In an embodiment of the present invention, the silicon anode may have a density of 2.0 to 2.4 g/cm³. When the density of the anode is within the range above, the electrochemical capacity of the silicon anode may be excellent. Specifically, the density of the silicon anode may be in the range described above, maintaining a higher density compared to a polycrystalline and/or polygranular silicon anode, thereby maintaining contact of a silicon active material in the process of insertion or removal of lithium. Furthermore, since the silicon anode in the range above may have a higher capacity compared to a polycrystalline and multiparticle silicon relative to the same volume, the silicon anode may have a higher energy density and excellent electrochemical characteristics.

In the present invention, the silicon anode may include pores, and the size and internal distribution of the pores may be uniform.

In an embodiment of the present invention, the porosity of the silicon anode may be 0.01 to 5%, 0.5 to 2%, or 0.1 to 1%. Here, the porosity means “(pore volume per unit mass)/(specific volume+pore volume per unit mass)” and may be measured by mercury porosimerty or Bruanuer-Emmett-Teller (BET) method.

A solid electrolyte material may be filled in the pores in the silicon anode of the present invention. Since the porosity of the anode of the present invention satisfies the range described above, a sufficient contact area may be secured between the anode and lithium metal serving as the active material layer, and the solid electrolyte filled in the pores, and excellent contact characteristics, low interfacial resistance, and high ionic conductivity between the anode and the solid electrolyte may be achieved.

In an embodiment of the present invention, the silicon anode may have a volume change rate of 10%, 8%, 6%, or 4% or less with charge and discharge. The pores distributed in the anode of the present invention and the solid electrolytes present in the pores absorb the volume expansion, thereby reducing the volume change rate of the silicon anode, and the cycle characteristics of the battery may not deteriorate even when the battery is repeatedly charged and discharged.

The present invention provides a solid-state battery including the anode described above. In an embodiment of the present invention, the solid-state battery may include a cathode collector; a cathode including a lithium composite oxide-based cathode active material formed on the cathode collector; the anode of the embodiment described above; and a solid electrolyte interposed between the cathode and the anode.

In an embodiment of the present invention, the solid electrolyte may be the same or different from the electrolyte included in the pores in the anode.

In an embodiment of the present invention, the solid electrolyte may be a sulfide-based solid electrolyte. The sulfide-based solid electrolyte may include a sulfide-based compound of Chemical Formula 1 below.

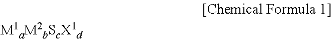

In Chemical Formula 1 above, M¹ is one or more species selected from alkali metals and alkaline earth metals, M² is Sb, Sn, Mg, Ba, B, Al, Ga, In, Si, Ge, Pb, N, P, As, Bi, Ti, V, Cr, Mn, Fe, Co, Ni, Cu, Y, Zr, Nb, Mo, Tc, Ru, Rh, Pd, Ag, Hf, Ta, W, or La, X¹ is F, Cl, Br, I, Se, Te or O, and 0<a≤6, 0<b≤6, 0<c≤6, and 0≤d≤6.

In an embodiment of the present invention, any polymer binder known to be available to be used for electrode formation may be used for the silicon anode, without any particular limitation. The binder is typically included with the solid electrolyte, and is a component added for purposes such as a process of slurry coating and adhesion of the solid electrolyte to the anode.

In an embodiment of the present invention, the binder may include, for example, at least one selected from the group consisting of acrylic-based binders, polyvinylidene fluoride (PVDF)-based binders, polytetrafluoroethylene (PTFE)-based binders, or butadiene rubber-based binders such as nitrile butadiene rubber (NBR), but is not limited thereto.

However, in order to achieve high energy density, it is preferred that the silicon anode substantially includes no binder, or includes 1 wt %, 0.5 wt %, or less than 0.1 wt %. As the binder is not substantially included in the silicon anode or is present within the range described above, the energy density of the electrode may be maximized.

In an embodiment of the present invention, the remaining components such as the anode and the cathode that exclude the solid electrolyte layer may conform to the configuration of a conventional solid-state battery. The cathode may include a cathode collector and a cathode active material layer positioned on the cathode collector.

The cathode active material layer is not particularly limited as long as it is a lithium composite oxide-based material capable of reversible insertion and removal of lithium ions. For example, the cathode active material may include one or more species of a metal of cobalt, manganese, nickel, iron, or a combination thereof, and a lithium composite oxide.

Next, a silicon anode for a solid-state battery according to another embodiment of the present invention will be described in detail.

A method of manufacturing a silicon anode for a solid-state battery according to an embodiment of the present invention may include etching a surface of a silicon anode including Si atoms of 99 wt % or more and composed of crystalline Si to form unevenness.

The etching may be performed to form unevenness on the surface of the silicon anode. Potassium hydroxide (KOH), tetramethylammonium hydroxide (TMAH), sodium hydroxide (NaOH), or ethylene diamine pyrocatechol (EDP) may be used as a solution for the etching.

Meanwhile, in order to control the roughness of the surface of the silicon anode, the concentration of the solution used for the etching may be 1 to 5 M. Preferably, the concentration of the solution used for the etching may be 2 to 4 M, more preferably 3 M.

Next, as with a conventional method of manufacturing an anode for a solid-state battery, the method may further include assembling the anode by stacking the silicon anode with unevenness formed on the surface onto one surface of a solid electrolyte pellet followed by pressing, and then stacking a metal alloy onto the opposite surface followed by pressing.

### EXAMPLES

Hereinafter, the present invention will be described in more detail with reference to examples. However, these examples are just for illustrative purposes and not intended to limit the scope of the present invention in any way.

### Example 1

A silicon wafer (manufactured by University Wafer company) was used as an anode. It was confirmed that the silicon wafer was plate-like, had a (110) crystallographic orientation, a thickness of approximately 200 μm, a long axis length (L) of approximately 0.4 cm, and a density of 2.2 g/cm³.

As a solid electrolyte, a sulfide-based solid electrolyte (Li6PS5Cl (manufactured by CIS company)) was manufactured as a solid electrolyte pellet under pressure of approximately 500 MPa for one minute. Then, the silicon wafer was placed on one surface of the electrolyte pellet as an electrode and then pressed at a pressure of approximately 650 MPa for approximately 5 minutes. Thereafter, an indium-lithium alloy was placed on the opposite surface and pressed at a pressure of approximately 250 MPa to complete a half cell. In this case, the loading amount of wafer (110) was 0.03263 g/cm².

### Example 2

The anode was manufactured as in Example 1, except that a silicon wafer having a (100) crystallographic orientation was used as the anode.

### Example 3

The anode was manufactured as in Example 1, except that a silicon wafer having a (111) crystallographic orientation was used as the anode.

### Example 4

The anode was manufactured as in Example 1, except that a silicon anode was used with an arithmetic average roughness (Ra) value of 3.5 μm by surface modification treatment of the silicon wafer with a 3M KOH solution for 24 hours.

### Comparative Example 1

The anode was manufactured as in Example 1, except that an anode consisting only of polycrystalline pure silicon particles having a particle size of approximately 6 μm was used instead of the silicon wafer as the anode.

### Comparative Example 2

The anode was manufactured as in Example 1, except that a 1.0 M electrolyte solution including LiPF₆ in ethylene carbonate (EC) and dimethyl carbonate (DMC) (1:1 v/v %) was used as the liquid electrolyte instead of the solid electrolyte, and there was no separate pressing process.

### EXPERIMENTAL EXAMPLES

### Experimental Example 1

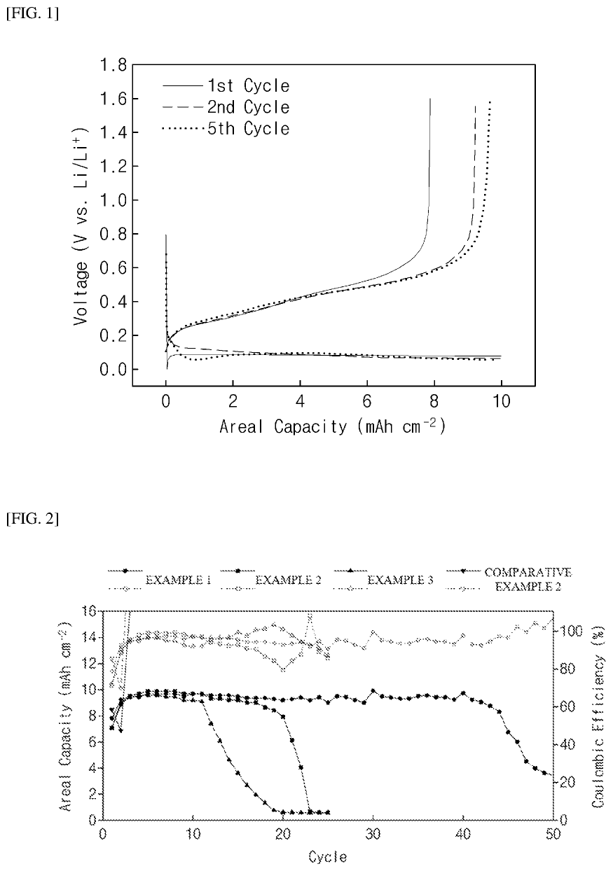

The half cell of Example 1 was tested for charge and discharge by fixing the charge and discharge rate to 0.5 mA/cm² at room temperature, which is illustrated in FIG. 1. As a result, it was confirmed that the capacity is up to 10 mAh/cm² at room temperature, which is higher than the conventional 4 mAh/cm². In addition, it was confirmed that the capacity remained without decrease for 40 cycles.

### Experimental Example 2

The half cells of Examples 1 to 3 and Comparative Example 2 were tested for charge and discharge by fixing the charge and discharge rate to 0.5 mA/cm² at room temperature, which is illustrated in FIG. 2. Meanwhile, in FIG. 2, the solid line indicates areal capacity according to the cycle, and the dotted line indicates Coulombic efficiency according to the cycle.

It was confirmed that in Examples 1 to 3 using the silicon wafer, there was no decrease in capacity for 10 cycles or more. In particular, it was confirmed that in Example 1, using the silicon wafer with the (110) crystallographic orientation, the capacity remained without decrease for 40 cycles or more, exhibiting the most excellent results. Meanwhile, in Comparative Example 2 using the liquid electrolyte, the measurement was not possible after 2 cycles.

### Experimental Example 3

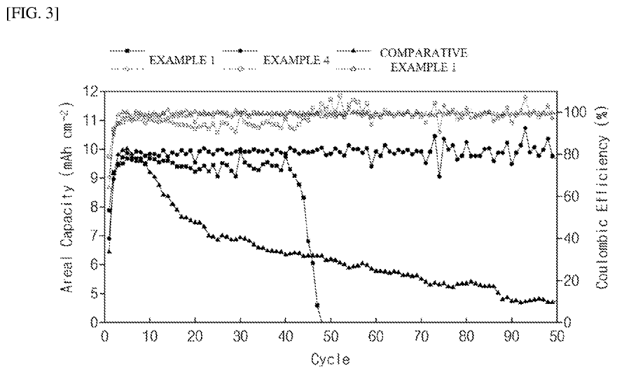

The half cells of Examples 1 to 4 were tested for charge and discharge by fixing the charge and discharge rate to 0.5 mA/cm² at room temperature, which is illustrated in FIG. 3. Meanwhile, in FIG. 3, the solid line indicates areal capacity according to the cycle, and the dotted line indicates Coulombic efficiency according to the cycle.

It was confirmed that in Example 4 using the silicon wafer including surface unevenness, the capacity remained without decrease for 100 cycles. Meanwhile, it was confirmed that in Example 1 using the plate-like silicon wafer, the capacity remained without decrease for 40 cycles or more. Therefore, it was confirmed that the silicon anode for a solid-state battery using the silicon wafer including surface unevenness can be driven to a longer cycle than the silicon anode for a solid-state battery using the plate-like silicon wafer.

1. A silicon anode for a solid-state battery comprising Si atoms of 99 wt % or more and composed of crystalline Si.

2. The silicon anode of claim 1, wherein the silicon anode has a plate-like shape with an average long axis length (L) of 1 to 500 mm.

3. The silicon anode of claim 1, wherein the silicon anode has a ratio (L/d) of an average long axis length (L) to an average thickness (d) of 5 to 100.

4. The silicon anode of claim 1, wherein the silicon anode is in the form of a wafer including unevenness on a surface thereof.

5. The silicon anode of claim 4, wherein an arithmetic average roughness (Ra) value of the surface of the silicon anode is 1 to 10 μm.

6. The silicon anode of claim 1, wherein a crystal orientation of the silicon anode comprises at least one selected from the group consisting of (100) plane, (110) plane, and (111) plane as a Miller index.

7. The silicon anode of claim 1, wherein the silicon anode has a density of 2.0 to 2.4 g/cm³.

8. The silicon anode of claim 1, wherein the silicon anode has a porosity of 0.1 to 1%.

9. The silicon anode of claim 1, wherein the silicon anode has a volume change rate of 10% or less with charge and discharge.

10. A solid-state battery comprising:
the silicon anode according to any one of claims 1 to 9;
a cathode; and
a solid electrolyte.

11. The solid-state battery of claim 10, wherein the solid electrolyte is a sulfide-based solid electrolyte.

12. The solid-state battery of claim 10, wherein the silicon anode does not substantially comprise a binder.

13. The solid-state battery of claim 10, wherein the silicon anode comprises a binder of less than 1 wt %.

14. A method of manufacturing a silicon anode for a solid-state battery, the method comprises etching a surface of a silicon anode including Si atoms of 99 wt % or more and composed of crystalline Si to form unevenness.

15. The method of claim 14, further comprising:
assembling the anode by stacking the silicon anode with unevenness formed on the surface onto one surface of a solid electrolyte pellet followed by pressing, and then stacking a metal alloy onto the opposite surface followed by pressing.
